(19) United States
(12) Patent Application Publication
(10) Pub. No.: US 2024/0209248 A1
(43) Pub. Date: Jun. 27, 2024

(54) ADHESIVE AND ADHESION METHOD USING THE SAME

(71) Applicant: KABUSHIKI KAISHA TOYOTA CHUO KENKYUSHO, Nagakute-shi (JP)

(72) Inventors: Izuru MIYAZAKI, Nagakute-shi (JP); Mitsutaro UMEHARA, Nagakute-shi (JP); Yumi SAIKI, Nagakute-shi (JP); Shinya MORIBE, Nagakute-shi (JP); Akitoshi SUZUMURA, Nagakute-shi (JP)

(73) Assignee: KABUSHIKI KAISHA TOYOTA CHUO KENKYUSHO, Nagakute-shi (JP)

(21) Appl. No.: 18/390,147

(22) Filed: Dec. 20, 2023

(30) Foreign Application Priority Data
Dec. 23, 2022 (JP) 2022-207015
Dec. 11, 2023 (JP) 2023-208477

(51) Int. Cl. C09J 187/00; C09J 5/06

(52) U.S. Cl. CPC C09J 187/00; C09J 5/06

(57) ABSTRACT

An adhesive comprises a colloidal solution in which a coordination polymer containing a transition metal such as zinc or cobalt and an azole such as at least one kind of imidazoles is dispersed in a dispersion medium such as an alcohol.

### BACKGROUND OF THE INVENTION

### Field of the Invention

The present invention relates to an adhesive and an adhesion method using the same.

### Related Background Art

In electronic component materials such as semiconductor elements and liquid crystal display elements, various members (adherends) are adhered with an adhesive. As such adhesives used in electronic component materials, polymer-based adhesives such as epoxy resin adhesives have conventionally been used. However, polymer-based adhesives have high coefficients of linear expansion and have a problem that when metal-made adherends are adhered, an adhered portion is damaged due to a change in temperature.

Hence, Japanese Unexamined Patent Application Publication No. 2022-530 (PTL 1) discloses, as an adhesive composition capable of suppressing peeling after a high-temperature and high-humidity treatment, an adhesive composition comprising: (a) a thermoplastic resin; (b) a silane compound having a urethane bond and an alkoxysilyl group in a molecule; (c) a radical polymerizable compound; and (d) a radically polymerization initiator, wherein the adhesive composition comprises (e) a compound having a urethane bond as (a) the component, (c) the component, or (d) the component, or as a component other than (a) the component, (b) the component, (c) the component, and (d) the component, and an average coefficient of linear expansion of a cured product at 30 to 90° C. is 800 ppm/K or less. In addition, PTL 1 also describes that peeling after a high-temperature and high-humidity treatment can be further suppressed by adding an insulating filler to the adhesive composition. However, since the adhesive composition described in PTL 1 has an average coefficient of linear expansion larger than coefficients of linear expansion of metals, even when an insulating filler is added, there is a problem that when metal-made adherends are adhered to each other, an adhered portion is damaged due to a change in temperature. In addition, there is also a problem that the addition of an insulating filler lowers an adhesion strength.

Furthermore, FIG. 1 in Noriaki Dokoshi et al., Polymers, 1970, vol. 19, No. 219, p.530-535 (NPL1) describes polybenzimidazole and polyimide as an adhesive having an excellent heat resistance. However, these adhesives have a heat resistance temperature (temperature at which the adhesion strength becomes 30% of the initial value after 100 hours of high temperature exposure) of 371° C., and do not necessarily have sufficient heat resistance.

On the other hand, as an adhesive using a coordination polymer, in Yanyi Zhao et al., ACS Nano, 2017, vol. 11, p. 3662 to 3670 (NPL 2), an adhesive using Ni (H₂O)₂[Ni (CN)₄ ]· 4H₂O, which is a Hofmann-type cyano-bridge coordination polymer is studied, and there is disclosed that adherends of a glass, a plastic, a metal, or the like can be adhered by using nanoflakes of a plate-shaped crystal of the Ni (H₂O) 2 [Ni (CN)₄ ]· 4H₂O which is made into a paste. However, there is a problem that an adhesive in the form of paste containing a solid powder has an insufficient adhesion strength because voids are likely to be formed in an adhesive layer after a solvent is removed by drying or the like.

### SUMMARY OF THE INVENTION

The present invention has been made in view of the above-described problems of the conventional techniques, and an object thereof is to provide an adhesive capable of forming an adhesive layer having a low coefficient of linear expansion, a high adhesion strength and an excellent heat resistance, and an adhesion method using the same.

As a result of earnestly conducting studies in order to achieve the above-described object, the present inventors have found that it is possible to form an adhesive layer having a low coefficient of linear expansion, a high adhesion strength and an excellent heat resistance by using, as an adhesive, a colloidal solution in which a coordination polymer of a metal-organic framework (MOF) or the like containing a transition metal and an azole is dispersed in a dispersion medium, and completed the present invention.

Specifically, the present invention provides the following aspects.
[1] An adhesive comprising a colloidal solution in which a coordination polymer containing a transition metal and an azole is dispersed in a dispersion medium.
[2] The adhesive according to [1], wherein the transition metal contains at least one selected from the group consisting of zinc and cobalt.
[3] The adhesive according to [1] or [2], wherein the transition metal is at least one selected from the group consisting of zinc and cobalt.
[4] The adhesive according to any one of [1] to [3], wherein the azole is at least one kind of imidazoles.
[5] The adhesive according to any one of [1] to [4], wherein the azole is imidazole or methylimidazole.
[6] An adhesion method comprising: forming an adhesive layer comprising the adhesive according to any one of [1] to [5] between adherends; and then heating the adhesive layer to 100 to 300° C. to cure the adhesive layer.
[7] The adhesion method according to [6], wherein a heating temperature to cure the adhesive layer is a temperature lower than a decomposition temperature of the coordination polymer.

Note that although it is not necessarily clear why an adhesive layer having a high reliability against a change in temperature and a high adhesion strength as well as an excellent heat resistance can be formed by using the adhesive of the present invention even when metal-made adherends are adhered to each other, the present inventors surmise as follows. Specifically, since the adhesive of the present invention comprises a colloidal solution in which a coordination polymer containing a transition metal and an azole is dispersed in a dispersion medium, crystal particles of the coordination polymer are generated by heating and curing this adhesive at a predetermined temperature. It is surmised that since this crystal of the coordination polymer has a very low coefficient of linear expansion as compared with polymer-based adhesives and has a coefficient of linear expansion comparable to metals, the adhesive layer is unlikely to expand due to a change in temperature and exhibits a high reliability even when metal-made adherends are adhered to each other. In addition, it is surmised that since the adhesive of the present invention is in the form of colloid, the adhesive exhibits favorable wetting properties to adherends and the crystal particles of the coordination polymer are highly densified by removing the dispersion medium through heating, and further, since the heating temperature at the time of curing can be set to be relatively high, it is possible to sufficiently remove impurities such as unreacted raw materials and the dispersion medium and impurities are unlikely to remain in the adhesive layer, so that the crystal particles of the coordination polymer are more highly densified and a high adhesion strength can be achieved. Furthermore, it is surmised that since the adhesive of the present invention is thermally stable, and is difficult to be thermally decomposed if exposed to high temperature, the adhesive can form the adhesive layer having an excellent heat resistance. Note that a “coordination polymer (CP)” is a complex having a continuous structure containing a polydentate ligand and metal ions and a “metal-organic framework (MOF)” is one having pores among the coordination polymers (CP).

The present invention makes it possible to form an adhesive layer having a low coefficient of linear expansion, a high adhesion strength and an excellent heat resistance.

### BRIEF DESCRIPTION OF THE DRAWINGS

FIG. 1 is a graph showing an XRD spectrum of a film (ZIF-67 crystal) obtained in Example 1.

FIG. 2A is a schematic perspective view showing an adhered body prepared in Examples 1 to 2 and Comparative Example 1.

FIG. 2B is a schematic view showing an outline of a shear test conducted in Examples 1 to 2 and Comparative Example 1.

FIG. 3 is a scanning electron microscope (SEM) image showing a longitudinal section of an adhered body obtained in Example 1.

### DETAILED DESCRIPTION OF THE PREFERRED EMBODIMENTS

Hereinafter, the present invention will be described in detail based on preferred embodiments thereof.

### [Adhesive]

First, an adhesive of the present invention will be described. The adhesive of the present invention comprises a colloidal solution in which a coordination polymer (CP) containing a transition metal and an azole is dispersed in a dispersion medium. The coordination polymer has a structure in which the azole is coordinated to the transition metal, and a polymer structure is formed by the van der Waals force and coordination bonds.

The transition metal is not particularly limited as long as it can form a coordination polymer in which an azole is coordinated, but from the viewpoint of environmental friendliness and rarity, Group 6 elements such as Cr, Group 7 elements such as Mn, Group 8 elements such as Fe, Group 9 elements such as Co, Group 10 elements such as Ni, Group 11 elements such as Cu, and Group 12 elements such as Zn and Cd are preferable, Cr, Mn, Fe, Co, Ni, Cu, Zn, and Cd are more preferable, Zn, Co, Mn, Ni, and Cu are further preferable, Zn and Co are particularly preferable. In addition, from the viewpoint that the adhesive layer having a high adhesion strength before or after high temperature exposure or both can be obtained, the transition metal preferably contains at least one selected from the group consisting of Zn and Co; and from the viewpoint that the adhesive layer having a high adhesion strength both before and after high temperature exposure can be obtained, the transition metal is more preferably at least one selected from the group consisting of Zn and Co.

The azole is not particularly limited as long as it can be coordinated to the transition metal to form a coordination polymer, and includes, for example, pyrroles, diazoles (for example, imidazoles and pyrazoles), triazoles, and tetrazoles. Among these azoles, from the viewpoint of coordination, imidazoles, pyrazoles, and triazoles are preferable, imidazoles, triazoles are more preferable, and imidazoles are particularly preferable. In addition, the imidazoles include imidazole, methylimidazole, benzimidazole, and the like. From the viewpoint that the adhesive layer having a high adhesion strength before or after high temperature exposure or both can be obtained, imidazole, methylimidazole, or a mixture thereof is preferable; and from the viewpoint that the adhesive layer having a high heat resistance can be obtained, imidazole or methylimidazole is more preferable.

In addition, the decomposition temperature of the coordination polymer is preferably higher than a heating temperature (hereinafter, also referred to as a “curing temperature”) to cure the adhesive of the present invention. In the case where the decomposition temperature of the coordination polymer is lower than the curing temperature, since the coordination polymer is decomposed by the heating to cure the adhesive, it tends to be difficult to form an adhesive layer having a high adhesion strength. Note that the decomposition temperature of the coordination polymer can be measured by thermal analysis such as thermogravimetric analysis (TGA).

Moreover, the coefficient of linear expansion of the crystal of the coordination polymer is preferably 20 ppm/K or less, and more preferably 10 ppm/K or less. An adhesive containing a coordination polymer of which the crystal has such a coefficient of linear expansion exhibits high reliability against a change in temperature even in the case where metal-made adherends are adhered to each other. Note that the coefficient of linear expansion of a coordination polymer crystal can be determined from a slope of a relation expression between a lattice constant and a temperature by measuring the temperature dependence of the lattice constant of the coordination polymer crystal determined based on an XRD spectrum obtained through X-ray diffraction (XRD) measurement.

Such a coordination polymer specifically includes those shown in Table 1.

TABLE 1

| | Decomposition point | Coefficient of |
|---|---|---|
| | (melting point) | linear expansion |
| Coordination polymer | [° C.] | [ppm/K] |
| [Zn(Im)₂] (ZIF-4) | 577 | 4.7 |
| [Zn(2-MeIm)₂] (ZIF-8) | 400 | 11.9 |
| [Co(2-MeIm)₂] (ZIF-67) | 270 | 8.9 |
| [Zn[Au(CN)₂]₂] | 350-390 | 5 |
| [Cd(2-MeIm)] (CdIF-1) | 500 | 4.5 |

Im = imidazolate
2-MeIm = 2-methylimidazolate

Among these coordination polymers, from the viewpoint of easiness of preparation of a colloidal solution, coordination polymers in which the transition metal contains at least one selected from the group consisting of Zn, Co and Cd, and the azole is at least one kind of the imidazoles (for example, [Zn (2-MeIm)₂], [Co (2-MeIm)₂], [Zn (Im)₂], and [Cd (2-MeIm)₂]) are preferable, and coordination polymers in which the transition metal is at least one selected from the group consisting of Zn and Co, and the azole is methylimidazole (for example, [Zn (2-MeIm)₂] and [Co (2-MeIm)₂]) are more preferable. In addition, from the viewpoint that the adhesive layer having a high adhesion strength before or after high temperature exposure or both can be obtained, coordination polymers in which the transition metal contains at least one selected from the group consisting of Zn and Co, and the azole is at least one kind of the imidazoles (for example, [Zn (2-MeIm)₂], [Co (2-MeIm)₂], [CoMn (2-MeIm)₂], [CoNi (2-MeIm)₂], [Zn (Im)₂], and [Zn₂ (2-MeIm) (Im)₃]) are preferable; from the viewpoint that the adhesive layer having a high heat resistance can be obtained, coordination polymers in which the transition metal contains at least one selected from the group consisting of Zn and Co, and the azole is imidazole or methylimidazole (for example, [Zn (2-MeIm)₂], [Co (2-MeIm)₂], [CoMn (2-MeIm)₂], [CoNi (2-MeIm)₂], and [Zn (Im) 2]) are more preferable; and from the viewpoint that the adhesive layer having a high adhesion strength both before and after high temperature exposure as well as having a high heat resistance can be obtained, coordination polymers in which the transition metal is at least one selected from the group consisting of Zn and Co, and the azole is methylimidazole (for example, [Zn (2-MeIm)₂] and [Co (2-MeIm)₂]) are further preferable.

The adhesive of the present invention comprises a colloidal solution in which such a coordination polymer is dispersed in a dispersion medium. Note that whether or not a solution in which a coordination polymer is dispersed in a dispersion medium is a colloidal solution can be checked from the presence or absence of the Tyndall phenomenon.

The dispersion medium is not particularly limited as long as the coordination polymer can be dispersed in the form of colloid therein, and includes, for example, alcohols such as methanol and ethanol; amides such as dimethyl formamide and diethyl formamide; amines such as diethylamine and triethylamine; sulfoxides such as dimethyl sulfoxide and diethyl sulfoxide; ketones such as acetone and diethyl ketone; and water, and from the viewpoint of easiness of curing through heating, alcohols and water are preferable, and methanol is particularly preferable.

In the colloidal solution, the average particle diameter of the coordination polymer, which is a dispersed phase, is preferably 1 to 150 nm, and more preferably 1 to 70 nm. If the average particle diameter of the coordination polymer is less than the lower limit, there is a tendency that crystallization is difficult in curing through heating, while if the average particle diameter of the coordination polymer is more than the upper limit, there is tendency that a colloidal solution cannot be obtained, so that precipitation of crystal grains is generated. Note that the average particle diameter of the coordination polymer in the colloidal solution can be obtained by removing a solvent through drying after application to a substrate, and then observation with a transmission electron microscope or the like.

The method for preparing such a colloidal solution is not particularly limited as long as the method allows the coordination polymer to be dispersed in the form of colloid in the dispersion medium, and includes, for example, a method including dissolving a compound containing the transition metal (preferably, a salt, a complex, or the like of the transition metal) and the azole in the dispersion medium, and agitating a solution thus obtained to generate a coordination polymer containing the transition metal and the azole in the form of colloid in the dispersion medium. The mixing ratio between the compound containing the transition metal and the azole may be set as appropriate in accordance with the stoichiometric proportion of each component of the obtained coordination polymer.

The colloidal solution prepared in this way can be used as the adhesive of the present invention as it is, but is preferably adjusted such that the solid content concentration of the adhesive becomes 0.1 mol/L or more (more preferably 0.5 mol/L or more, and particularly preferably 1 mol/L or more). If the solid content concentration of the adhesive is less than the lower limit, there is a tendency that the strength of the adhesive decreases. Note that the upper limit of the solid content concentration of the adhesive is not particularly limited, but is preferably 20 mol/L or less, more preferably 10 mol/L or less, and particularly preferably 5 mol/L or less from the viewpoint of the wetting properties to substrates. The method for adjusting (increasing) the solid content concentration of the adhesive includes, for example, a method including removing the dispersion medium from the obtained colloidal solution by drying or the like. The drying condition and the like for the colloidal solution may be set as appropriate so as to obtain a desired solid content concentration, and for example, the colloidal solution may be dried at room temperature, or may be heated at a temperature of 100° C. or less (preferably, a temperature of 50° C. or less).

### [Adhesion Method]

Next, an adhesion method of the present invention will be described. The adhesion method of the present invention comprises forming an adhesive layer comprising the adhesive of the the present invention between adherends; and then heating the adhesive layer to 100 to 300° C. to cure the adhesive layer.

### (Adhesive Layer Forming Step)

In the adhesion method of the present invention, first, an adhesive layer comprising the adhesive of the present invention is formed between adherends. Specifically, the adhesive layer can be formed between adherends by applying an appropriate amount of the adhesive of the present invention on an adherend (preferably, a metal-made adherend), and then disposing another adherend (preferably, another metal-made adherend) thereon.

### (Curing Step)

Next, the adhesive layer formed between the adherends is heated at 100 to 300° C. to be cured. In this way, the coordination polymer in the adhesive layer is crystallized and the dispersion medium in the adhesive layer is removed, and thus, crystal particles of the coordination polymer are agglomerated and highly densified, so that the adherends are adhered to each other with a high adhesion strength.

The lower limit of the heating temperature (curing temperature) to cure the adhesive layer is preferably 150° C. or more, more preferably 200° C. or more, and particularly preferably 230° C. or more from the viewpoint that this makes it possible to sufficiently remove unreacted raw materials and the dispersion medium, and makes impurities unlikely to remain in the adhesive layer, so that the crystal particles of the coordination polymer are even more highly densified and the adhesion strength is improved. On the other hand, the upper limit of the heating temperature (curing temperature) to cure the adhesive layer is preferably a temperature lower than the decomposition temperature of the coordination polymer, and more preferably a temperature 30° C. lower than the decomposition temperature of the coordination polymer from the viewpoint of suppressing decomposition of the coordination polymer due to the heating and forming an adhesive layer having a high adhesion strength.

In addition, when the adhesive layer is cured, the adhesive layer is preferably heated while being pressurized. This further removes unreacted raw materials and the dispersion medium and makes impurities even unlikely to remain in the adhesive layer, so that the crystal particles of the coordination polymer are even more highly densified and the adhesion strength is further improved. The pressurization condition is preferably 1 MPa or more, more preferably 20 MPa or more, and particularly preferably 40 MPa or more.

### EXAMPLES

Hereinafter, the present invention will be more specifically described based on Examples and Comparative Example; however, the present invention is not limited to the following Examples. Note that the solid content concentrations of the adhesive were determined by the following method.

### (Solid Content Concentration of Adhesive)

The volume of a colloidal solution or slurry after raw materials were dissolved in a solvent was precisely weighed out, and the solvent was removed at 50° C. by using a hot plate. The mass of a solid component thus obtained was precisely weighed out, and the solid content concentration of this colloidal solution or slurry was calculated. By using this value, the amount of the solid component of the colloidal solution or slurry when actually used for adhering is calculated by precisely weighing out the volume.

### Example 1

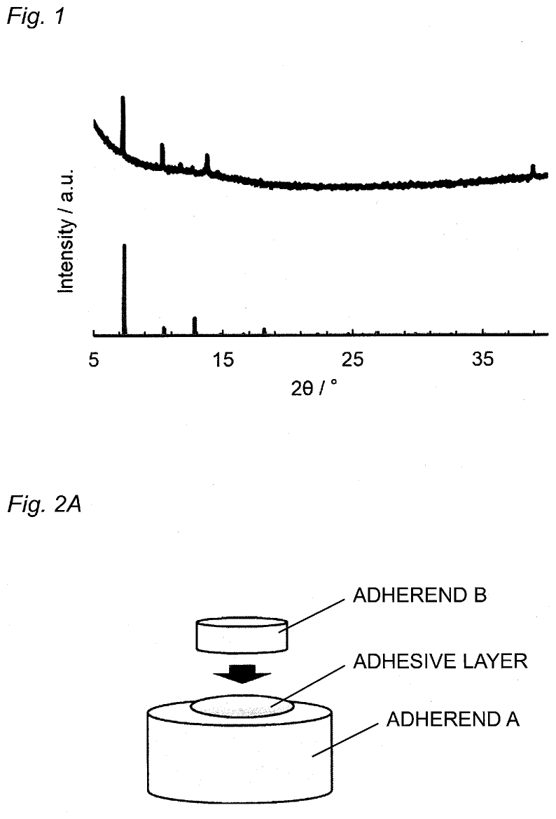

First, a colloidal solution of ZIF-67 ([Co (2-MeIm)₂]) was prepared in accordance with the method described in Z. Chen et al., Angew. Chem. Int. Ed., 2021, Vol. 60, Issue 25, p. 14124-14130. Specifically, 2.49 g of cobalt (II) acetate tetrahydrate and 3.284 g of 2-methylimidazole were dissolved in 100 ml of methanol, followed by agitating at room temperature for 24 hours. Since the Tyndall phenomenon was observed, it was confirmed that the solution thus obtained was a colloidal solution. Note that the average particle diameter of the ZIF-67 particles, which were a dispersed phase of this colloidal solution, was about 40 nm (Z. Chen et al., Angew. Chem. Int. Ed., 2021, Vol. 60, Issue 25, p. 14124-14130). In addition, the decomposition point of the ZIF-67 particles was determined by thermogravimetric analysis (TGA) and was 270° C. In addition, this colloidal solution of ZIF-67 was applied onto a plate of oxygen-free copper C1020, followed by heating at 250° C. for 300 seconds to form a film. The XRD spectrum of the film thus obtained is shown in FIG. 1. It was confirmed that this corresponded with that of the ZIF-67 crystal.

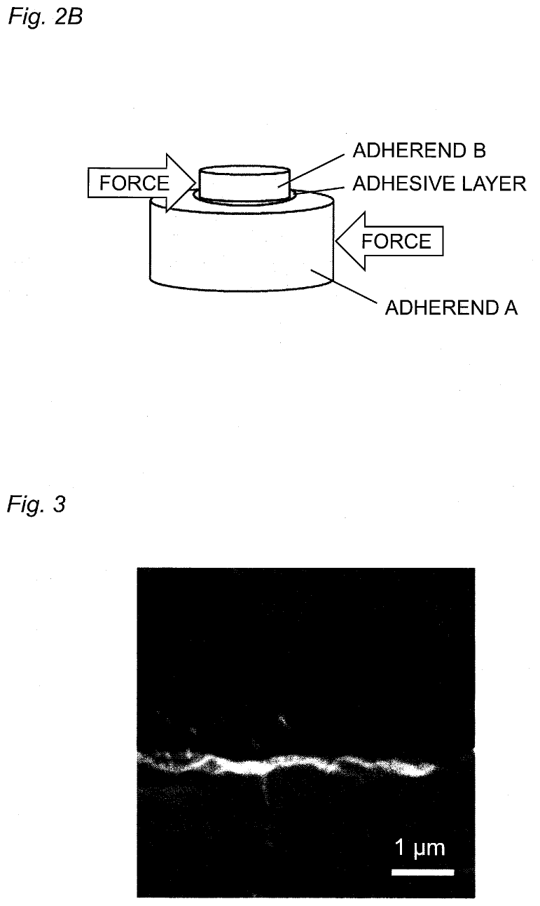

Next, this colloidal solution of ZIF-67 was dried at room temperature for 48 hours to prepare an adhesive having a solid content concentration of 5 mol/L. Two copper disks were adhered to each other by using this adhesive as shown in FIG. 2A. Specifically, an appropriate amount of the adhesive was applied to a center portion (having a diameter of 5 cm) on a disk-shaped test piece (an adherend A in FIG. 2A, having a diameter of 10 mm and a thickness of 5 mm) of oxygen-free copper C1020 to form an adhesive layer. On this adhesive layer, a disk-shaped test piece (an adherend B in FIG. 2A, having a diameter of 5 mm and a thickness of 2 mm) of oxygen-free copper C1020 was placed, followed by heating at 250° C. for 300 seconds while pressurizing at 45 MPa to cure the adhesive layer and adhere the two copper disks (the adherends A and B in FIG. 2A) to each other.

### [Shear Strength]

The obtained adhered body (obtained by adhering the adherends A and B) was subjected to a shear test by using a compression testing machine (built by ourselves using a “digital force gauge” manufactured by IMADA Co., Ltd.) in the atmosphere at a loading speed of 1 mm/min as shown in FIG. 2B to measure the shear strength. The result is shown in Table 2.

### [Scanning Electron Microscope Observation]

The longitudinal section of the obtained adhered body (obtained by adhering the adherends A and B) was observed by using a scanning electron microscope (SEM). The result is shown in FIG. 3. From the SEM image of FIG. 3 and the result of the XRD spectrum diagram shown in FIG. 1 in combination, it is considered that crystal particles of ZIF-67 were generated by heating the adhesive containing the colloidal solution of ZIF-67, and these were densely agglomerated to achieve a high adhesion strength (shear strength).

[Heat Resistance and Shear Strength after High Temperature Exposure]

The obtained adhered body (obtained by adhering the adherends A and B) was subjected to a heat resistance test by heating at respective temperatures in range of 100 to 650° C. for 100 hours in the atmosphere using a muffle furnace. Shear strengths at the respective heat resistance test temperatures were measured, and a heat resistance test temperature at which the shear strength decreased to 30% of the shear strength before the heat resistance test was determined. This heat resistance test temperature was used as an indicator for heat resistance evaluation. The result is shown in Table 2. In addition, the shear strength at a heat resistance test temperature of 600° C. as a shear strength after high temperature exposure was shown in Table 2.

### Reference Example 1

A powder of ZIF-67 was obtained as a precipitate in the same manner as in Example 1 except that 2.9 g of cobalt (II) nitrate hexahydrate was used instead of cobalt (II) acetate tetrahydrate. This powder was washed twice with a sufficient amount of methanol, followed by drying in the atmosphere for 24 hours to obtain a crystal powder of ZIF-67. The lattice constants of the ZIF-67 crystal at the respective heating temperatures were determined based on the XRD spectra of the obtained ZIF-67 crystal powder at the respective heating temperatures from room temperature to 300° C., and these lattice constants were plotted to the heating temperatures, and the coefficient of linear expansion of ZIF-67 was determined from a slope of an approximate expression (a relation expression between the heating temperatures and the lattice constants), and was 8.9 ppm/K.

### Example 2

First, a colloidal solution of ZIF-8 ([Zn (2-MeIm)₂]) was prepared in accordance with the method described in Z. Chen et al., Angew. Chem. Int. Ed., 2021, Vol. 60, Issue 25, p. 14124-14130. Specifically, 2.195 g of zinc acetate (II) dihydrate and 3.284 g of 2-methylimidazole were dissolved in 100 ml of methanol, followed by agitating at room temperature for 24 hours. Since the Tyndall phenomenon was observed, it was confirmed that the solution thus obtained was a colloidal solution. Note that the average particle diameter of the ZIF-8 particles, which were a dispersed phase of this colloidal solution, was about 130 nm (Z.Chen et al., Angew. Chem. Int. Ed., 2021, Vol. 60, Issue 25, p. 14124-14130). In addition, the decomposition point of the ZIF-8 particles was determined by thermogravimetric analysis (TGA) and was 400° C.

Next, this colloidal solution of ZIF-8 was dried at room temperature for 48 hours to prepare an adhesive having a solid content concentration of 5 mol/L. Two copper disks were adhered to each other in the same manner as in Example 1 except that this adhesive was used. The shear strength before the high temperature exposure, the heat resistance and the shear strength after the high temperature exposure of the obtained adhered body (obtained by adhering the adherends A and B) were measured in the same manner as in Example 1. These results are shown in Table 2.

Note that the coefficient of linear expansion of ZIF-8 is known to be 11.9 ppm/K (F. Sapnik et al., Chem. Commun, 2018, Vol. 54, Issue 69, p. 9651 to 9654).

### Example 3

First, a methanol solution containing [CoMn (2-MeIm) 2] particles was prepared in the same manner as in Example 1 except that 249 mg of cobalt (II) acetate tetrahydrate and 245 mg of manganese (II) acetate tetrahydrate were used instead of 2.49 g of cobalt (II) acetate tetrahydrate, and the amount of 2-methylimidazole (2-MeIm) was changed to 656.8 mg. Since the Tyndall phenomenon was observed, it was confirmed that the solution thus obtained was a colloidal solution. Note that the average particle diameter of the [CoMn (2-MeIm)₂] particles, which were a dispersed phase of this colloidal solution, was about 100 nm. In addition, the decomposition point of the [CoMn (2-MeIm)₂] particles was determined by thermogravimetric analysis (TGA) and was 400° C.

Next, this colloidal solution of [CoMn (2-MeIm)₂] was dried at room temperature for 48 hours to prepare an adhesive having a solid content concentration of 5 mol/L. Two copper disks were adhered to each other in the same manner as in Example 1 except that this adhesive was used. The shear strength before the high temperature exposure, the heat resistance and the shear strength after the high temperature exposure of the obtained adhered body (obtained by adhering the adherends A and B) were measured in the same manner as in Example 1. These results are shown in Table 2.

Note that according to I. Miyazaki et al., Small, 2023, 19, 2300298, metal organic frameworks (MOFs) have a low coefficient of linear expansion corresponding to metals. Therefore, it was considered that the [CoMn (2-MeIm)₂], which was a zeolitic imidazolate framework (ZIF) that was one of the metal organic frameworks (MOFs), had a low coefficient of linear expansion corresponding to metals.

### Example 4

First, a methanol solution containing [CoNi (2-MeIm)₂] particles was prepared in the same manner as in Example 1 except that 249 mg of cobalt (II) acetate tetrahydrate and 248 mg of nickel (II) acetate tetrahydrate were used instead of 2.49 g of cobalt (II) acetate tetrahydrate, and the amount of 2-methylimidazole (2-MeIm) was changed to 656 mg. Since the Tyndall phenomenon was observed, it was confirmed that the solution thus obtained was a colloidal solution. Note that the average particle diameter of the [CoNi (2-MeIm)₂] particles, which were a dispersed phase of this colloidal solution, was about 80 nm. In addition, the decomposition point of the [CoNi (2-MeIm)₂] particles was determined by thermogravimetric analysis (TGA) and was 400° C.

Next, this colloidal solution of [CoNi (2-MeIm)₂] was dried at room temperature for 48 hours to prepare an adhesive having a solid content concentration of 5 mol/L. Two copper disks were adhered to each other in the same manner as in Example 1 except that this adhesive was used. The shear strength before the high temperature exposure, the heat resistance and the shear strength after the high temperature exposure of the obtained adhered body (obtained by adhering the adherends A and B) were measured in the same manner as in Example 1. These results are shown in Table 2.

Note that according to I. Miyazaki et al., Small, 2023, 19, 2300298, metal organic frameworks (MOFs) have a low coefficient of linear expansion corresponding to metals. Therefore, it was considered that the [CoNi (2-MeIm)₂], which was a zeolitic imidazolate framework (ZIF) that was one of the metal organic frameworks (MOFs), had a low coefficient of linear expansion corresponding to metals.

### Example 5

First, an ethanol solution containing ZIF-zni ([Zn (Im)₂]) particles was prepared in the same manner as in Example 1 except that 197 mg of zinc acetate (II) dihydrate was used instead of 2.49 g of cobalt (II) acetate tetrahydrate, 272 mg of imidazole (Im) was used instead of 2-methylimidazole, and 70 ml of ethanol was used instead of methanol. Since the Tyndall phenomenon was observed, it was confirmed that the solution thus obtained was a colloidal solution. Note that the average particle diameter of the ZIF-zni particles, which were a dispersed phase of this colloidal solution, was about 130 nm. In addition, the decomposition point of the ZIF-zni particles was determined by thermogravimetric analysis (TGA) and was 577° C.

Next, this colloidal solution of ZIF-zni was dried at room temperature for 48 hours to prepare an adhesive having a solid content concentration of 5 mol/L. Two copper disks were adhered to each other in the same manner as in Example 1 except that this adhesive was used. The shear strength before the high temperature exposure, the heat resistance and the shear strength after the high temperature exposure of the obtained adhered body (obtained by adhering the adherends A and B) were measured in the same manner as in Example 1. These results are shown in Table 2.

Note that according to I. Miyazaki et al., Small, 2023, 19, 2300298, metal organic frameworks (MOFs) have a low coefficient of linear expansion corresponding to metals. Therefore, it was considered that the ZiF-zni, which was a zeolitic imidazolate framework (ZIF) that was one of the metal organic frameworks (MOFs), had a low coefficient of linear expansion corresponding to metals.

### Example 6

First, an ethanol solution containing [Zn₂ (2-MeIm) (Im)₃] particles was prepared in the same manner as in Example 2 except that the amount of zinc acetate (II) dihydrate was changed to 198 mg, 24 mg of 2-methylimidazole (2-MeIm) and 156 mg of imidazole (Im) was used instead of 3.284 g of 2-methylimidazole, and 100 ml of ethanol was used instead of methanol. Since the Tyndall phenomenon was observed, it was confirmed that the solution thus obtained was a colloidal solution. Note that the average particle diameter of the [Zn₂ (2-MeIm) (Im)₃] particles, which were a dispersed phase of this colloidal solution, was about 250 nm. In addition, the decomposition point of the [Zn₂ (2-MeIm) (Im)₃] particles was determined by thermogravimetric analysis (TGA) and was 500° C.

Next, this colloidal solution of [Zn₂ (2-MeIm) (Im)₃] was dried at room temperature for 48 hours to prepare an adhesive having a solid content concentration of 5 mol/L. Two copper disks were adhered to each other in the same manner as in Example 1 except that this adhesive was used. The shear strength before the high temperature exposure, the heat resistance and the shear strength after the high temperature exposure of the obtained adhered body (obtained by adhering the adherends A and B) were measured in the same manner as in Example 1. These results are shown in Table 2.

Note that according to I. Miyazaki et al., Small, 2023, 19, 2300298, metal organic frameworks (MOFs) have a low coefficient of linear expansion corresponding to metals. Therefore, it was considered that the [Zn₂ (2-MeIm) (Im)₃], which was a zeolitic imidazolate framework (ZIF) that was one of the metal organic frameworks (MOFs), had a low coefficient of linear expansion corresponding to metals.

### Comparative Example 1

First, a slurry of ZIF-8 was prepared. Specifically, 2.19 g of commercially available ZIF-8 particles (zinc 2-imidazole, produced by Sigma-Aldrich, an average particle diameter: about 300 nm) was dispersed in 100 ml of methanol, followed by agitating at room temperature for 24 hours. The obtained slurry did not exhibit the Tyndall phenomenon, and was separated into two phases and ZIF-8 particles precipitated before too long after the preparation.

Next, this slurry of ZIF-8 was dried at room temperature for 48 hours to prepare an adhesive having a solid content concentration of 5 mol/L. Two copper disks were adhered to each other in the same manner as in Example 1 except that this adhesive was used. The shear strength before the high temperature exposure of the obtained adhered body (obtained by adhering the adherends A and B) was measured in the same manner as in Example 1 and was a lower detection limit (1 N) or less.

TABLE 2

| | | | | Shear strength | | Shear strength |
|---|---|---|---|---|---|---|
| | | | | before high- | Heat | after high- |
| | Transition | | | temperature | resistant | temperature |
| | metal | Azole | Solvent | exposure [MPa] | [° C.] | exposure [MPa] |
| Ex. 1 | Co | 2-MeIm | Methanol | 28.8 | 600-650 | 21.1 |
| Ex. 2 | Zn | 2-MeIm | Methanol | 21.5 | 600-650 | 20.5 |
| Ex. 3 | Co/Mn | 2-MeIm | Methanol | 8.7 | >600 | 15.3 |
| Ex. 4 | Co/Ni | 2-MeIm | Methanol | 24.1 | >600 | 8.8 |
| Ex. 5 | Zn | Im | Ethanol | 31.6 | >600 | 11.2 |
| Ex. 6 | Zn | 2-MeIm/Im | Ethanol | 32.2 | <600 | 6.3 |

2-Melm = 2-methylimidazole
Im = imidazole

As shown in Table 2, the adhered body prepared using the adhesive of the present invention exhibited the high shear strength before and after the high temperature exposure and had the excellent heat resistance. Therefore, it was confirmed that the adhesive of the present invention was excellent in the adhesion strength before and after the high temperature exposure and the heat resistance. In particular, it was found that the adhesive containing only Co as the transition metal (Example 1), the adhesives containing only Zn as the transition metal (Examples 2, 5, and 6), the adhesive containing only Co and Ni as the transition metal (Example 4) were excellent in the adhesion strength before the high temperature exposure, compared with the adhesive containing Co and Mn as the transition metal (Example 3). Furthermore, it was found that the adhesives containing only 2-methylimidazole or imidazole as the azole (Examples 1 to 5) were excellent in the heat resistance, compared with the adhesive containing 2-methylimidazole and imidazole as the azole (Example 6). Moreover, it was found that the adhesives containing only Co or Zn as the transition metal and only 2-methylimidazole as the azole (Examples 1 and 2) were excellent in the adhesion strength after the high temperature exposure, compared with the adhesives containing Co and Mn as the transition metal (Example 3), the adhesives containing Co and Ni as the transition metal (Example 4), and the adhesives containing imidazole as the azole (Examples 5 and 6).

As described above, the present invention makes it possible to form an adhesive layer having a low coefficient of linear expansion, a high adhesion strength and an excellent heat resistance. Therefore, since the adhesion method using the adhesive of the present invention can adhere metal-made adherends to each other with a high adhesion strength and a high reliability against a change in temperature, the adhesion method is useful as a method for adhering metal-made members in electronic component materials such as semiconductor elements and liquid crystal display elements, and metal-made members for brake linings of aircraft, and the like.

What is claimed is:

1. An adhesive comprising a colloidal solution in which a coordination polymer containing a transition metal and an azole is dispersed in a dispersion medium.

2. The adhesive according to claim 1, wherein
the transition metal contains at least one selected from the group consisting of zinc and cobalt.

3. The adhesive according to claim 1, wherein
the transition metal is at least one selected from the group consisting of zinc and cobalt.

4. The adhesive according to claim 1, wherein
the azole is at least one kind of imidazoles.

5. The adhesive according to claim 1, wherein
the azole is imidazole or methylimidazole.

6. The adhesive according to claim 2, wherein
the azole is at least one kind of imidazoles.

7. The adhesive according to claim 2, wherein
the azole is imidazole or methylimidazole.

8. The adhesive according to claim 3, wherein
the azole is at least one kind of imidazoles.

9. The adhesive according to claim 3, wherein
the azole is imidazole or methylimidazole.

10. An adhesion method comprising:
forming an adhesive layer comprising the adhesive according to claim 1 between adherends; and then
heating the adhesive layer to 100 to 300° C. to cure the adhesive layer.

11. The adhesion method according to claim 6, wherein
a heating temperature to cure the adhesive layer is a temperature lower than a decomposition temperature of the coordination polymer.
